(19) United States
(12) Patent Application Publication
(10) Pub. No.: US 2011/0213480 A1
(43) Pub. Date: Sep. 1, 2011

(54) PARAMETRIC PRODUCT CONFIGURATION SYSTEM

(75) Inventors: Vladimir Zila, Markham (CA); Zuzana Zila, Markham (CA); Christopher Adam Sinclair, Toronto (CA); Jason Joseph Manuel, Toronto (CA)

(73) Assignee: Genexis Design Inc., Markham (CA)

(21) Appl. No.: 12/715,033

(22) Filed: Mar. 1, 2010

(51) Int. Cl. G06F 17/50; G06N 5/02

(52) U.S. Cl. 700/98; 700/107; 700/104

(57) ABSTRACT

A generic, integrated, parametric, automated product configuration system for parametric configuration of products such as offices on a building space plan. The system can produce bills of materials, costings and manufacturing drawings in real-time at the request of a user as the user specifies and configures the product components and parameters values. The system provides for real time three-dimensional visualization and editing of the product as it is configured. It also includes a rule engine for validating the product and automatically incorporating missing necessary components in a configuration in real-time as the user configures a product.

### FIELD OF THE INVENTION

The invention relates to computerized parametric configuration systems and more particularly to a software application for designing configurations of configurable products.

### BACKGROUND OF THE INVENTION

Many systems have been developed to provide design and modeling functions for assembling components into a product and customizing the product to a user's specifications. For example, they may allow users to design rooms, and place objects, such as furniture into those rooms. These systems employ custom software running on a user's computer, either in a standalone mode, or as a client that interacts with a server.

Such design systems are typically built around the type of product they are intended to configure, and therefore do not allow for dynamic programming of the configuration functionality, or for new products to be incorporated quickly and easily. Furthermore they have limited or no ability to directly generate bills of materials, manufacturing drawings and accurate and immediate costing information, and if such a function is available, its logic is typically hard-coded to the configuration product. Commercially available computer-aided design (CAD) programs, such as AutoCAD and engineering computer-aided design (EGAD) programs, such as Pro/ENGINEER, SolidWorks and CATIA, can be used to generate bills of materials and manufacturing drawings, which is their primary purpose; however such systems are not designed to provide generic product configuration capability, or accurate and immediate costing. CAD/ECAD programs can be used to build systems for configuring products, however such applications will typically not allow dynamic changes of configuration logic or easy modifications to the configuration architecture without cumbersome reprogramming of the logic. Such configuration logic creations and modifications are time consuming, and require the involvement of highly skilled and highly paid CAD operators and programmers. In CAD/ECAD based product configuration applications, there are inherent time delays in the processing of each configuration request due to the time required, for example, for accessing the CAD/ECAD license, launching the software, loading the configuration product models and drawings, updating the models and drawings, creating output files in 2D and/or 3D format, translating the 2D/3D files into other formats, and displaying the information in viewable applications outside of the CAD/ECAD application (e.g. in a browser window).

If CAD and EGAD are used in product configuration applications, they require two or more databases with different sets of data—one database, which contains all CAD/ECAD related data (such as models and drawings), and the other database (or databases) containing non-CAD/ECAD data related to the configuration product and process. Such independent data sets create information islands requiring extensive measures to ensure the data is synchronized, accurate and up-to-date, which leads to large maintenance overhead and a potential for human-induced errors.

Another disadvantage of CAD/ECAD based configuration applications is that they have limited scalability—only one configuration request can be processed at the time on a single machine with a CAD/ECAD license, which creates processing bottlenecks and excessive needs for expensive software licenses and hardware.

Even though some systems exist that operate in a client-server configuration, these require custom or non-standard software to be installed and run on the client system, which increases installation, support and maintenance costs for using these systems.

Such existing systems also generally do not have the capability to validate designs, or such capability is very limited. Nor do they have any capability to automatically detect and correct errors in designs, such as missing components that are necessary to the integrity of the design.

Thus there is a need for a system that can address some or all of these deficiencies.

### SUMMARY OF THE INVENTION

The invention relates to product configuration system comprising:
a. A sketcher module for generating and displaying a product design from parameterized model configurations in real-time as a user specifies the model configurations and their parameter values; and
b. A dynamic assembly logic module for generating a costing and a bill of materials for the product design at the request of the user as the user specifies the model configurations and their parameter values.

The sketcher module and dynamic assembly logic module may be implemented in software designed to run on one or more programmable processors.

The model configurations may include wall panels and doors.

The dynamic assembly logic module may also automatically generate manufacturing drawings at the request of the user.

The system may further comprise a rule engine module for validating the product design in real-time as the user specifies the model configurations and their parameter values. The rule engine module may also identify model configurations missing from the product design and automatically add them to the product design. The rule engine module evaluates parameter values for validity and compare multiple parameters against each other.

The system may further comprise a logic converter module for importing a parametric EGAD model.

The sketcher may be able to import a reference floor plan produced by an offline CAD program.

The costing may be computed based on the model configuration parameter values.

The sketcher module may run on a client computer system and the dynamic assembly logic module may run on a server computer system in electronic communication with the client computer system via a network. The sketcher module may run in a browser window using only commercial off-the-shelf software.

The system may generate three-dimensional visualizations of the product design in real-time as the user edits the product design and display the visualizations to the user. The user may be able to edit the product design by selecting and modifying components in the product design in a three-dimensional visualization.

### BRIEF DESCRIPTION OF THE FIGURES

FIG. 1 is a high-level dataflow diagram showing the key functionality of a preferred embodiment.

FIG. 2 is an example of a screen produced by the sketcher showing a 2D space plan for an office space.

FIG. 3 is an example of a screen produced by the sketcher showing a 2D space plan beside a 3D view of the office space.

FIG. 4 is an example of a costing report for a sketched office space.

FIG. 5 is a flow chart showing the processing performed by the rule engine in one embodiment.

FIG. 6 shows the process flow of the Dynamic Assembly Logic System module.

FIG. 7 shows the process flow of costing generation for the configuration product.

### DETAILED DESCRIPTION

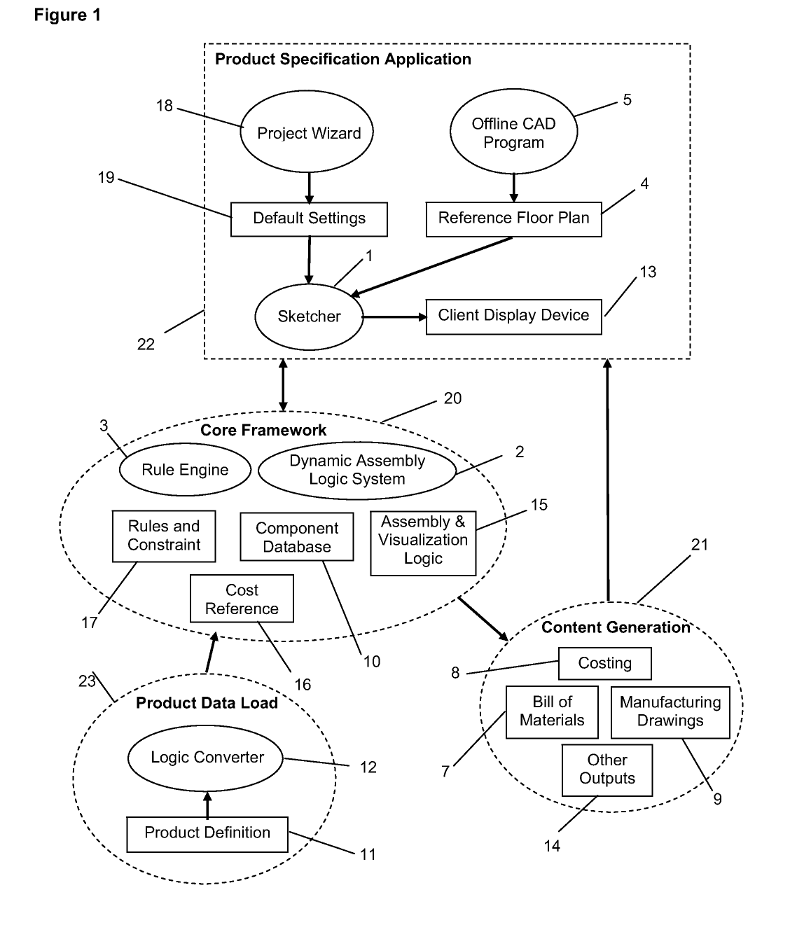

In a preferred embodiment depicted in FIG. 1, the system includes the following main components: a Product Specification Application 22, the Core Framework 20, the Product Data Load 23, and Content Generation 21. The Product Specification Application 22 is a custom application (such as a web site, rich internet application, or desktop application, that can interface with the Core Framework 20) designed to meet the needs of the particular type of product being configured. The Core Framework 20 contains the Product Definition Implementations, the validation provided by the Rule Engine 3 (also referred to as the rule engine module), and the content generation provided by the Dynamic Assembly Logic System 2 (also referred to as the dynamic assembly logic module). The Product Data Load 23 refers to the processes and methods in which users would typically transfer the knowledge and materials in the Product Definition 11 into the various forms to create the internal Product Definition Implementation in the Core Framework 20. Content Generation 21 covers all the methods that the system uses to create usable information or content about the configuration product (e.g., 3D visualization, costing, manufacturing drawings, etc.)

In the preferred embodiment, the Product Specification Application includes a sketcher 1 which is a computer-aided design drafting application that a user interacts with via computer input and output devices, including a client display device 13. The user may use the sketcher 1 to draft a meaningful depiction of the configuration product, or product design, in the preferred embodiment represented by a space plan. The user may import a reference floor plan 4 into the sketcher 1 to be used as a template against which the configuration product is drawn. The reference floor plan 4 may reside on a server, and be generated by an offline CAD program 5, such as AutoCAD.

The sketcher 1 is more generally a configurable module designed to meet the needs of the particular type of product being configured. For example, for the configuration of file cabinets, the sketcher 1 may be configured to be a streamlined parameter input interface rather than a space plan computer-aided drafting application. Regardless of the intended usage, the Product Specification Application would interface with the Core Framework 20 for content generation, validation, and other advanced functionality.

In the embodiment shown in FIG. 1, the sketcher 1 is a CAD drafting application that the user interacts with via computer input and output devices, including a client display device. The sketcher 1 may run, for example, on the user's computer in a browser window. The user may draft a space plan using the sketcher 1, or may import a reference floor plan 4.

A reference floor plan 4 may be very large so if it is located on a server, specialized client-server communication and rendering methods are necessary to make the reference floor plan 4 scalable to any size regardless of the user's connection speed and computing power. The system provides the ability to track the client's view and serve to the client only the portions of the reference floor plan 4 that are currently visible. Thus the client only downloads portions and is scalable to extremely large reference floor plans 4.

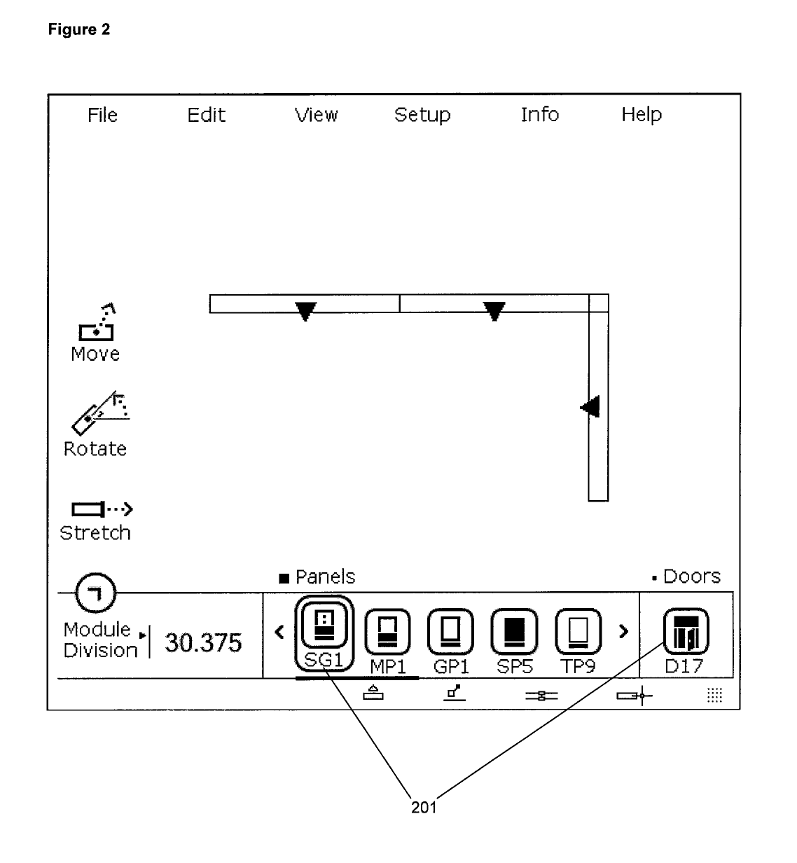

An example sketcher 1 window is shown in FIG. 2. The sketcher 1 allows the user to draw a space plan consisting of a number of parameterized model configurations and/or model families, such as wall panels, doors and connectors representing components of the configuration product. The model configurations and model families may be represented by icons 201, which may be used in the drawing of the space plan.

Model configurations such as walls, panels or doors, can be selected by the user and automatically drawn into the space plan by the user indicating the intended location with a mouse or other mechanism. The user may specify the required parameter values for each model configuration, or the parameter values may be pre-specified as default settings 19. Standard editing and markup functions such as rotating items, copy and paste, stretching, splitting, dimensioning, and adding of notes may also be provided.

The sketcher 1 may also pass model configurations to the rule engine 3 for validation in real-time as they are being used for drafting. The rule engine 3 may analyze the model configurations used during drafting to determine whether additional model configurations are required, or detect if current model configurations and their usages are valid. If any invalid conditions are found, this information may be passed to the sketcher 1, which may take appropriate actions, such as adding new model configurations or informing the user.

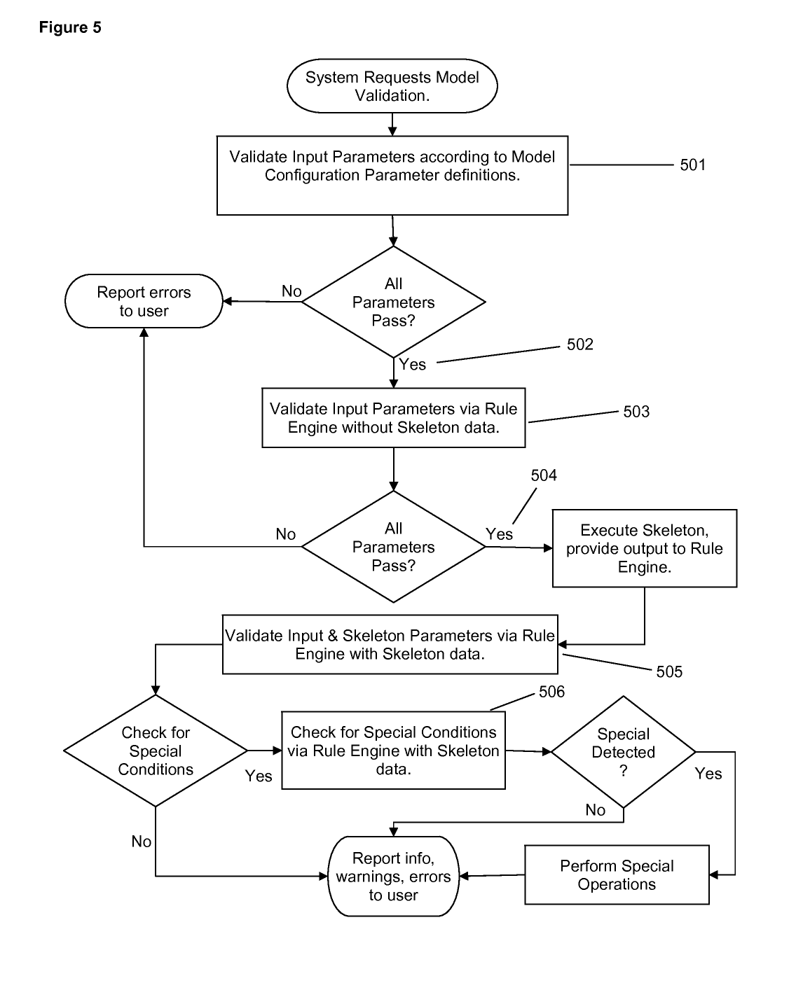

Rules and constraints 17 may be entered by users to define simple or very complex rules that govern validation of the product as it is being configured. The high-level algorithm for validating a model is shown in FIG. 5.

Rules can be written to inspect and compare parameter values to ensure that they are valid and will not result in errors or non-manufacturable variants of the configuration product. Validation occurs on three levels: parameter type constraints, basic rule engine validation, and rule engine validation using the product configuration skeleton (also referred to as the “skeleton”).

A product configuration skeleton is an analytical, abstract design plan of a configuration product, containing top-level assembly information about all components and subsystems, product-specific geometric and non-geometric attributes and properties. Geometric attributes may include, for example, spatial references of the assembly, interfaces and interactions between components and subsystems, motion rules and constraints, and design information between subsystems. Non-geometric attributes may include parameters, materials, physical properties (weights, volumes, etc.), part numbers, descriptions, and other product-specific metadata. A skeleton can be a singular, central source of information that may be leveraged by multiple parts of the configuration system, such as 3D visualization, costing, and rule engine validation. The skeleton is typically very complex as it defines the core product in an abstract, generic way, and encompasses most, if not all configuration possibilities. The Core Framework 20 may include a separate module to process the skeleton so that its code and behavior may be maintained apart from content generation, and changes may be automatically propagated throughout the system.

Parameter type constraints check against simple data-driven rules: ranges, sets, regular expressions to validate input parameters according to model configuration parameter definitions 501. This not only provides an easy way to validate simple rules, but also to ensure that the proper type of data is passed to the complex rules. For example, letters may not be fed into a number-only parameter, or a ceiling height parameter might define that the ceiling height must be between 60 and 144 inches.

If the first stage passes validation 502 then basic rule engine validation allows users to define more complex rules and compare multiple parameters against each other 503. Based on a combination of input parameters, certain configurable constraints for the configuration product may be violated. For example, the height of an inset piece of glass could not be configured to be taller than the frame surrounding it. Additionally, these rules may validate that the parameters are valid for the product configuration skeleton.

If the second stage passes validation 504 then product configuration skeleton rule engine validation 505 will execute the product configuration skeleton, if any are available, to provide geometrical, manufacturing or other product-specific data to the rule engine. For example, a rule may check all the resultant glass panes that are created to see if they are within the size constraints of the particular glass type used. The rules in the second 503 and third 505 stages are defined using dynamically executed instructions which allows for extremely complex conditions.

There may also be rules defined to check for special or non-standard conditions 506. For example, rules can be defined that would determine if model configuration parameters used would produce a technically manufacturable variant of the configuration product, which would not be considered a standard offering. For instance, a standard offering might consist of only 48 inch tall glass panes, whereas a configuration with a 49.625 inch tall glass pane could still be theoretically manufactured but would have to be handled as non-standard variant of the configuration product.

Rules may consist of a collection of conditions and a single consequence. Conditions may be functions that operate on input parameters and return “true” if the condition is met and “false” otherwise. If the condition is met, the consequence is executed. These typically will validate the current parameter being checked.

In addition to validating the physical configuration product, rules may be defined that control how parameters are displayed to the user. Rules may determine that some model configuration parameters are no longer applicable for a given model configuration (e.g., do not provide an input to select a glass texture if the door is configured to be solid wood). Rules may also provide feedback to alter the behavior of a parameter, providing informative messages to the user (e.g., “doors must be at least 90 inches tall to meet regulations”), may alter the visualization or user interface to input the parameter value, or may provide any custom metadata information for the implemented embodiment to work with. Similarly, the implemented embodiment may pass metadata to the rule engine 3 to be accessed by the product-specific rules to alter their execution. The metadata is passed between rules and the implemented embodiment in the form of key-value pairs. The key-values are not fixed to a single type (i.e. non-typed), therefore nested and complex data structures can be fed into or out of the rule engine 3 regardless of the specific embodiment's implementation.

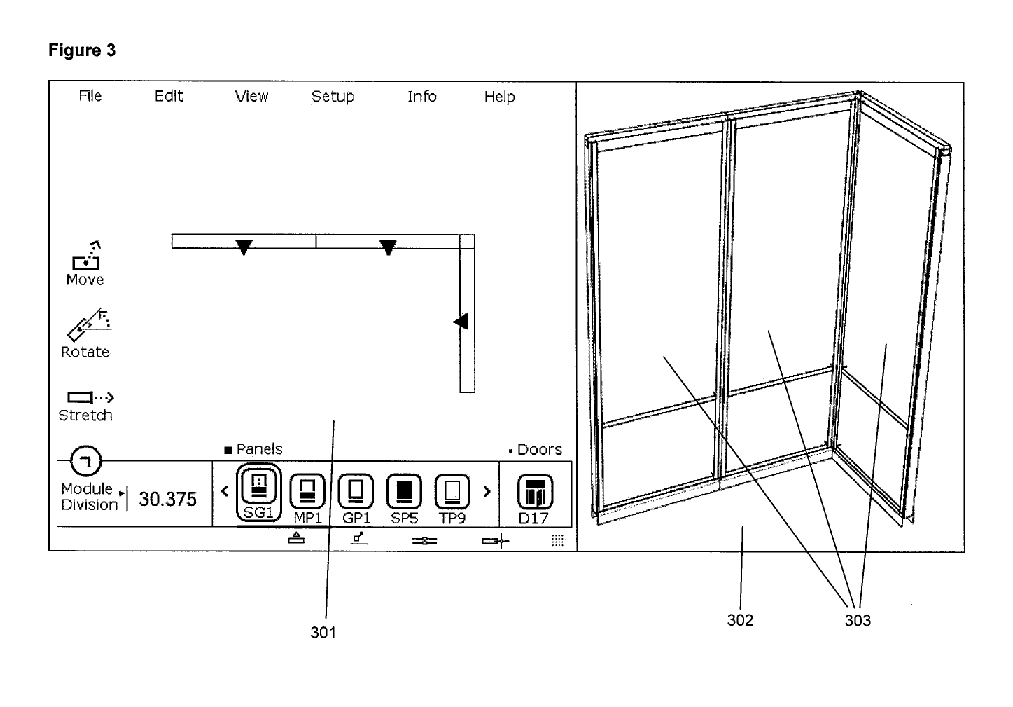

In addition to providing client-based sketching or drafting, the system may also provide three-dimensional (3D) rendering of the product design as it is being created. For example, FIG. 3 shows a sample display generated by the sketcher 1 with a two-dimensional (2D) view 301 beside the corresponding 3D view 302. The user may select objects in the 3D view 302 and edit them. For example the user may select a set of glass panels 303 and replace them with solid panels in the 3D view 302. As changes are made (replacing glass with solid), the sketcher 1 communicates with the server to configure the new panel types. Then it communicates with a 3D interactive client application (e.g. Shockwave) to provide it with location, rotation, and configuration information of the drafted product. The 3D interactive client application in turn requests that the server produce 3D visualization information. This visualization information is downloaded back to the 3D interactive client application which then displays it to the client device. This requires the seamless communication and execution of two separate client applications to two separate server modules.

Alternatively the sketcher 1 may operate in a purely 3D mode in which all configuring and editing is done using a displayed 3D view of the configuration product.

The model configuration may be sent to the Core Framework 20, which may reside on a server system, in order to produce 3D visualizations. The assembly logic 15 then executes using the component database 10 and skeleton to assemble the model configuration. The Dynamic Assembly Logic System 2 then creates 3D data in a generic format, which may be fed into custom-written libraries to convert it into a 3D PDF, Wavefront OBJ, or into a hardware-accelerated (or software executed) DirectX, OpenGL, or other high-end ray tracing rendering engine to create images. The converted data may be then transmitted as a response back to the client request where a client application displays or saves the data accordingly.

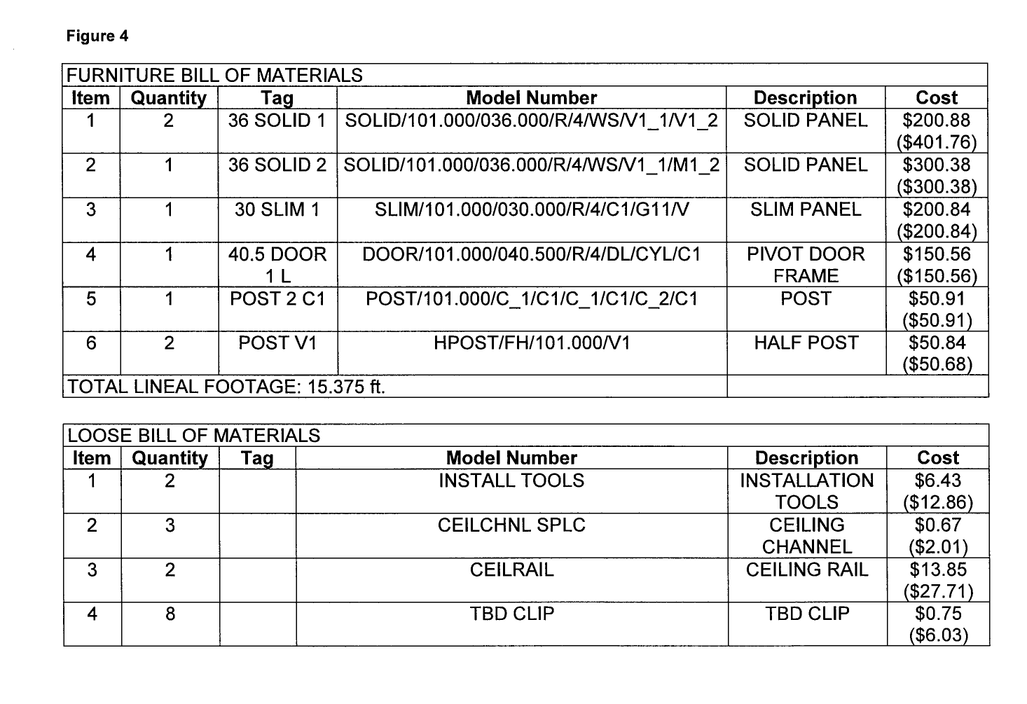

As the design of the configuration product is created in the Product Specification Application 22, the user may request that the system produce a bill of materials 7, costing 8, or manufacturing drawings 9. In that case the Product Specification Application 22 may send the model configuration to the Core Framework 20, which may then generate a bill of materials 7, costing 8, or manufacturing drawings 9 as requested by the user. An example of a bill of materials (BOM) 7 and costing 8 is shown in FIG. 4.

The Core Framework 20 may also generate other outputs 14, such as DXF, DWG, 3D PDF and mesh files. The Core Framework 20 is integrated with cost references 16, which includes tables that can be updated independently. For example, this allows data-entry personnel to maintain industry costs for raw materials without requiring knowledge of the assembly system or the configuration product. The Dynamic Assembly Logic System 2 and the cost references 16 may be revision controlled so that a product design costed and archived at a certain time will always show the same costing in the future, based on the costs at the time the product was configured. Alternatively a user may choose to have the Core Framework 20 update the costing information to produce a current, up-to-date cost breakdown for an old product design.

The cost references 16 may specify costs associated with raw materials (e.g. an aluminum extrusion), finished materials (e.g. an anodized extrusion), finishes (e.g. pounds of paint, number and type of panes of glass), labor (such as the labor in work minutes required to drill or punch holes) and other costs such as packaging and shipping. The costs are associated with entries in the component database 10 for use by the assembly and visualization logic 15 to compute costings 8. The cost references 16 can be updated independently of the components and assemblies in the component database 10 to reflect changes in material costs on the fly. The costs are specified parametrically so that the costing can be computed based on the parameter values for a model configuration. For example, the cost of extruded aluminum may be specified to be $0.10 per inch. In this case, the cost of the extruded aluminum would be computed as the cost per inch multiplied by the required length. The cost could be modified to $0.12 per inch and the costing will reflect this immediately without any changes required to be made to the model configuration or assembled parts. For labor, the cost may be computed as work units multiplied by a labor wage. The system may provide for specifying a proportional overhead rate calculated as a specified percentage of the labor cost, or a custom overhead cost independent of labor.

An advantage of this parametric system is that costing and bills of materials can even be generated on an interim basis, as each model configuration is developed, or at other interim stages in the space plan design. The user can clearly see the configuration (in 2D or 3D) and cost it at the same time, and make iterative changes to the design as necessary.

In some cases, a look-up table may be used, for example for a part that has several hundred different length and width combinations for which there are different costs and no mathematical formula that precisely expresses the cost in terms of the length and width.

The Core Framework 20, which is described in more detail below, may use a standard off-the-shelf EGAD system to assist in the production of manufacturing drawings 9 or other manufacturing information without the need for manual intervention.

A space plan project may have model configuration families, such as posts, doors, connectors, and panels. Model configurations may be defined and maintained in a hierarchical tree of Global, Generic and Instance model configurations. Although these three levels are typical, there may be fewer or more levels as configuration products require. Every created model configuration uses the properties of the model family that it belongs to.

Model families have a number of parameters that define the model configuration. For example, a panel may be parameterized by various parameters such as base cover height and manufactured height. Parameters that are defined to be ranges may have an associated lower and upper bound on the acceptable values.

Global Parameters or “Globals” are used as a common template to ensure that each model configuration (e.g. represented by a panel or a door) follows the same set of rules that control visual appearance or logical relations of the models assembled to form the final product design. For example, panels and doors, which are assembled into walls in the space plan, may have matching key design elements (such as aligned horizontal transitions in adjacent panels). Since individual model configurations (e.g. panels and doors) do not “know” where they are assembled in the wall context, or space plan context, Globals provide the highest level of common rules, pertinent to each individual model family and model configuration within the product design.

Globals may be used, for example, to control transition alignments or horizontal visual gaps across groups of models. Their parameters determine, for example, the overall number of transitions and their placement rules, height of the base cover and overall ceiling height independently of any specific model family. Any models inheriting parameters from the same Global will be guaranteed to visually align common visual elements, such as horizontal transitions, or horizontal visual gaps, if set side-by-side.

Generic model configurations, or “Generics”, are used to configure attributes of a specific model family such as finishes, transition placements used, panel or door heights, and other parameters uniquely defining each model family. Generic model configurations inherit parameters from their parent Global. Properties such as “width” are relegated to the child Instance configurations and referred to as “Identity Parameters” as they represent a fully defined variant of the configuration product as intended for manufacturing.

A Generic model configuration has all configuration parameters specified except, for example, the “width” for panel families. As soon as an object (e.g. panel, door, wall) is sketched with a set width (e.g. 42 inches), an instance model configuration with this width is automatically created under the respective generic model configuration. Every time a different width is configured for a particular generic model configuration, a new instance is created from it (unless this width was already defined for this generic model—in this case the instance with the previously defined width will be selected for sketching). So the “Generic” is the parent and the “Instance” is the child.

Instance configurations inherit all the properties (finishes, height, etc.) of their parent Generic, which in turn also inherits the properties of the associated Global. These configurations, representing the fully defined variant of the configuration product, are drafted in the plan view of the sketcher 1. They may be submitted to the Core Framework 20 to produce manufacturing drawings, bills of materials, costings, and visualizations.

Typical model configurations may follow a hierarchy such as the described three-level hierarchy of Global>Generic>Instance. Using this hierarchy to its full potential is a very powerful tool. By organizing model configurations into this logic, they can all be linked and easily and quickly modified. By modifying any parameter of a parent configuration, all the children update accordingly. For example, if a design is produced using model configurations (such as panels or doors) with a 4″ base cover height in the whole layout, and it is determined later that a 5″ height is required, the user need only change the single “Base Cover” parameter of the Global. In doing so, the change immediately propagates to all the configured Generics and drafted instance model configurations. In a similar way parameters such as “Global Ceiling Height” or “Number of Horizontal Visual Lines” can be changed and propagated from the Global level.

Configuration product components may be grouped into model families, such as doors, and placed in a component database 10 where they may be accessed by the Product Specification Application 22 for use in product designs, by the rule engine 3 for validation and by the Dynamic Assembly Logic System 2 for rendering visualizations, generation of bills of materials 7 and costings 8.

A project wizard 18 may be used to set up default settings 19 for use in a project. The default settings 19 may include various default parameters, such as the default finish and floor type, such as tiled, carpeted or granite, to be used by the Product Specification Application 22 for product designs in a given project.

The user may upload Product Definition 11 or 3D files and have them placed in the component database 10 and use them as part of the model configurations and visualizations. Users may define instructions to be associated with a Product Definition 11 part or assembly. These instructions may define how the part behaves, is used, how it visually appears, and how it is costed based on input parameters. 3D visualizations can be generated by using custom instructions and/or by uploading 3D mesh files created by a third party external 3D modeler. Users define the generic appearance and assembly of the product, while the core system handles placement of that visualization into the 3D space plan as drafted and rotated.

The costing and BOM generation are completely parametric. This may be very high level, such as being based on a cost per model configuration, or may be as low-level as desired, such as being based on labor hours and costs of individual parts such as screws and paint usage. Along with visualizations, the user may define costs associated with the component parts or assemblies. Depending on the simplicity or the complexity of the product line, assemblies may be very “high-level” (consisting of only one or two assemblies that represent a model family) or very “low-level” (detailed constructions consisting of nested assemblies or parts and costs).

Users can define the costs associated with the specific parts and assemble them to represent a model family based on the input parameters. The Core Framework 20 handles aggregating parts, quantities, costs and price lookups (cost references) and doing so recursively for all drafted model configurations in a space plan.

If aspects of the Product Definition 11 are in compatible EGAD software, they may be imported by processing them through a Logic Converter 12. This allows the Product Definition 11 to be easily maintained and modified, and any changes are propagated through the system automatically. In this case, the product configuration skeleton may exist outside the system in an EGAD application, such as Pro/ENGINEER. The Logic Converter 12 translates from EGAD program code into compatible instructions that the system can read and execute.

The Dynamic Assembly Logic System (DALS) is designed to assist in the fulfillment of Content Generation Requests. It allows users to analytically implement the Product Definition 11 in a form that the system can use and leverage to construct a virtual representation of the model configuration. Once a virtual representation of the model configuration is constructed, DALS may extract pertinent information (e.g., 3D geometry and texturing, costing, etc.) from it depending on the nature of the Content Generation Request. Users may define logical collections of entities (“DALS Objects”) that represent individual parts, assemblies, costs, abstract concepts, or other essential qualities of the Product Definition 11. These entities may be dynamically created and modified on-the-fly and may be automatically propagated throughout the system. When changes are made to the DALS Objects, they are compiled into the native system language and stored in the database to be easily retrieved and executed on demand.

Whenever the Product Specification Application 22 requires some data tied to the Product Definition 11, it makes a Content Generation Request to the Core Framework 20. The Content Generation Request may indicate what type of data is needed (e.g., 3D visualization, costing or manufacturing drawings) and any pertinent information required (e.g., model configuration parameters, file format or image resolution) to generate that data. Depending on the nature of the request, the Core Framework 20 may follow different processes or methods to generate the data and fulfill that request. Content Generation Requests may be fulfilled on-the-fly synchronously (e.g., 2D image visualizations), or may be placed into a processing queue depending on how long the request may take to fulfill (e.g., manufacturing drawings may take a minute). Content Generation Requests may be initiated externally from a Product Specification Application or may be initiated internally as a subset or recursive process within the Core Framework 20 to fulfill other Content Generation Requests.

The Product Definition 11 may refer to all materials, drawings, physical properties, constraints, costing information, and other relevant data that describe the particular configuration product. Examples of the configuration product may be, for example, architectural wall panels and doors, cabinets, interior design and decoration, electrical installations, HVAC planning, or auditorium seating. It may even be applied to more abstract, non-physical products such as personnel or inventory management. The Product Definition 11 may exist in several forms such as manufacturing drawings, digital engineering models, spreadsheets, databases, manufacturing limitations, knowledge and training, or any other medium that may exist outside of the system.

The Core Framework 20 typically resides in a central location such as a server, and provides various interfaces or methods of interacting with its content and functionalities. Some or all of its capabilities may be utilized depending on the current embodiment used. The Core Framework 20 may consist of three key components: the Product Definition Implementation, Framework Processing, and the component database. The Framework Processing may handle the administration, management, and intercommunication of these components. It may also provide and manage the external interfaces through which particular embodiments and Product Specification Applications leverage the advanced functionality of the Core Framework 20 such as configuration validation and Content Generation (3D visualization, manufacturing drawings, etc.). The component database may consist of a combination of a standard database system and separate content related files (EGAD assets, processed data caches, finishes/materials raster images for 3D visualization, etc.) to reduce the database system load.

The Product Definition Implementation refers to the data, logic, and assets loaded into the Core Framework 20 that provides a virtual representation of the configuration product. The Product Definition Implementation may be stored in various forms that are managed and executed by the Core Framework 20. The Product Definition Implementation consists of key components in specific forms as follows:
product configuration skeleton in the form of executable instructions;
Component Listing which typically represent parts and assemblies that serve as containers to house Assembly Logic, Costing Logic, and Visualization Logic;
Assembly Logic which dictates how the virtual representations of configuration product are constructed based on model configuration parameters and which may be stored as executable instructions and associated with items in the Component Listing;
Visualization Logic in the form of executable instructions which dictates how individual parts or assemblies in the Component Listing physically look in 3D space;
Costing Logic in the form of executable instructions which dictates how individual parts or assemblies in the Component Listing cost based on the assembled model configuration and its properties;
Cost References in the form of flat information database records which may be associated with Costing Logic;
3D Assets in the form of 3D meshes and textures (typically generated in industry standard 3D modeling software) which may be referenced by the Visualization Logic to produce custom, complex, or unique 3D visuals;
Libraries of Finishes or Materials in the form of metadata and raster images that may be assigned to product configurations and leveraged by the Visualization Logic;
Product Validation Rules in the form of executable instructions which validates or perform special behavioral tasks based on model configuration parameters;
ECAD Assets in the form of a compatible format for the particular back-end ECAD Application used in the current embodiment (e.g., Pro/ENGINEER or SolidWorks model assemblies, parts and drawings) which may be leveraged to produce manufacturing drawings and/or manufacturing bills of materials; and
Model Families, in the form of data-driven database records, associate content in the Production Definition Implementation together into logical groups (e.g., Panels, Doors, Posts) and define model configuration parameters for users of the system to specify.

Although typical embodiments will likely use all of the above components in some capacity to maximize usability and functionality, it is not required that the Product Definition Implementation employ all of these components and is dependent on the intended usage. For example, a particular embodiment may not require the generation of manufacturing drawings and as such the ECAD Assets need not be implemented.

The Product Data Load refers to the processes and methods in which users would typically transfer the knowledge and materials in the Product Definition 11 into the various forms to create the internal Product Definition Implementation in the Core Framework 20. The Core Framework 20 may provide several interfaces (typically web-browser based, but not necessarily so) to allow users to load the data with semi-automated or fully automated methods. An example of semi-automated data load is the writing of the Product Validation Rules, Assembly Logic, Costing Logic, or Visualization Logic where users may employ an interface to write instructions which the Core Framework 20 then automatically combines with internal house-keeping instructions and compile into natively executable instructions. These instructions may then be saved as part of the Product Definition Implementation. An example of a fully automated data load would be the ability to create a product configuration skeleton simply by supplying the system with an existing logic set that is in a compatible language (such as Pro/ENGINEER Relation code). When the user provides the supported instructions, the system will automatically translate it into a usable format for the Core Framework 20, combine it with internal house-keeping instructions, and compile it into natively executable instructions. Manual processes might come in the form of directly feeding the database with information (such as a Cost Reference database, or a listing of Finishes and Materials). Once the initial Product Data Load is completed for a particular embodiment, the same process would continue on a much smaller scale to handle changes to the product design over time. The exact process would vary from one embodiment to the other and may not require a complete one-to-one translation of the product design depending on the intended use of the embodiment.

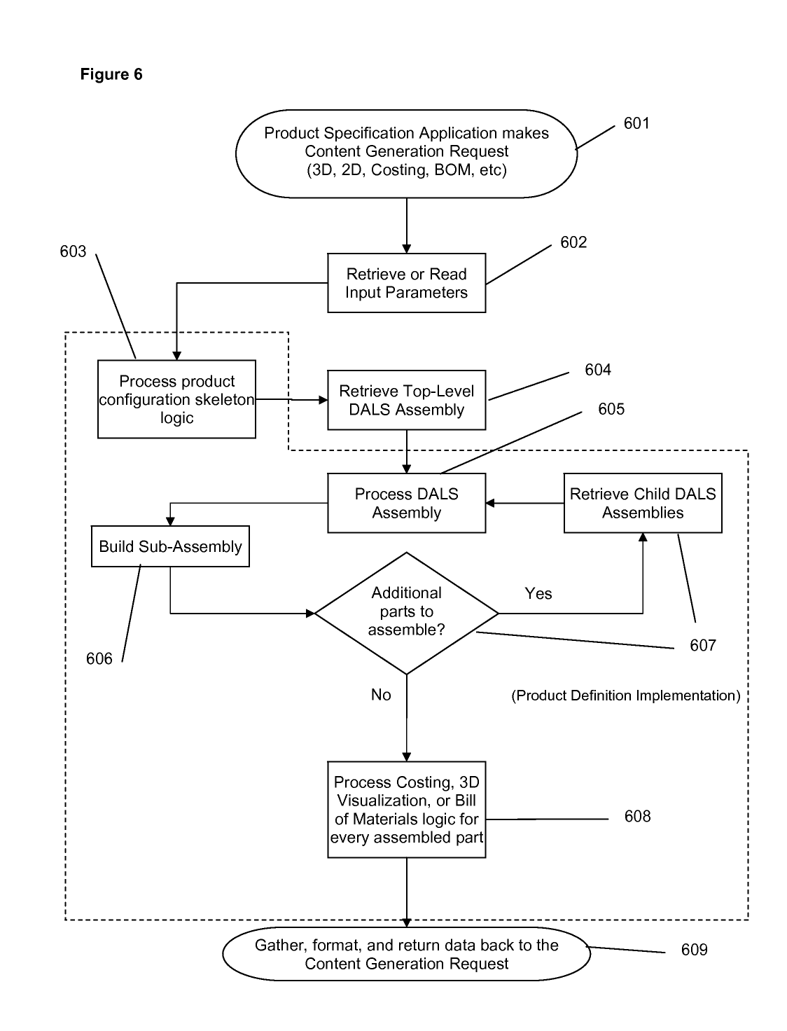

The Dynamic Assembly Logic System process flow, depicted in FIG. 6, may begin with a Content Generation Request 601, which may be initiated by an action by a user or as a subset or recursive process of another Content Generation Request. (e.g., Users may make a Content Generation Request to generate costing for a collection of ten panels, and that Content Generation Request in turn makes ten separate Content Generation Requests 601 to DALS to build each virtual representation of the model configuration and extract their respective costs.) Once the Content Generation Request 601 is received, DALS may Read or Retrieve any pertinent Input Parameters 602 including the associated model family. These parameters may be fed into the product configuration skeleton 603 and the associated analytical instructions will be executed. The results of the processed product configuration skeleton may then be passed to a Top-Level Assembly 604 that is associated with the current model family. It should be noted that in typical embodiments the product configuration skeleton is leveraged, but this is not required for all Product Definitions 11 and may be bypassed. DALS will then execute any assembly logic stored in the retrieved Top-Level Assembly 605 which typically consists of checking Input Parameters 602 and adding appropriate Sub-Assemblies or Parts 606. If the user logic has added additional Sub-Assemblies or Parts, DALS will then recursively execute the logic of those newly added entities and so on until no more assembled parts remain to be processed 607. Once DALS has completed assembling the virtual representation of the model configuration, it will execute for all assembled parts any logic 608 associated with the current Content Generation Request 601 (e.g., it will run Costing logic for building a BOM and not bother executing 3D visualization logic). Finally, the results of this process (3D visualization data, Costing data, etc.) is passed back to the originator of the Content Generation Request 601 where it may be used accordingly 609.

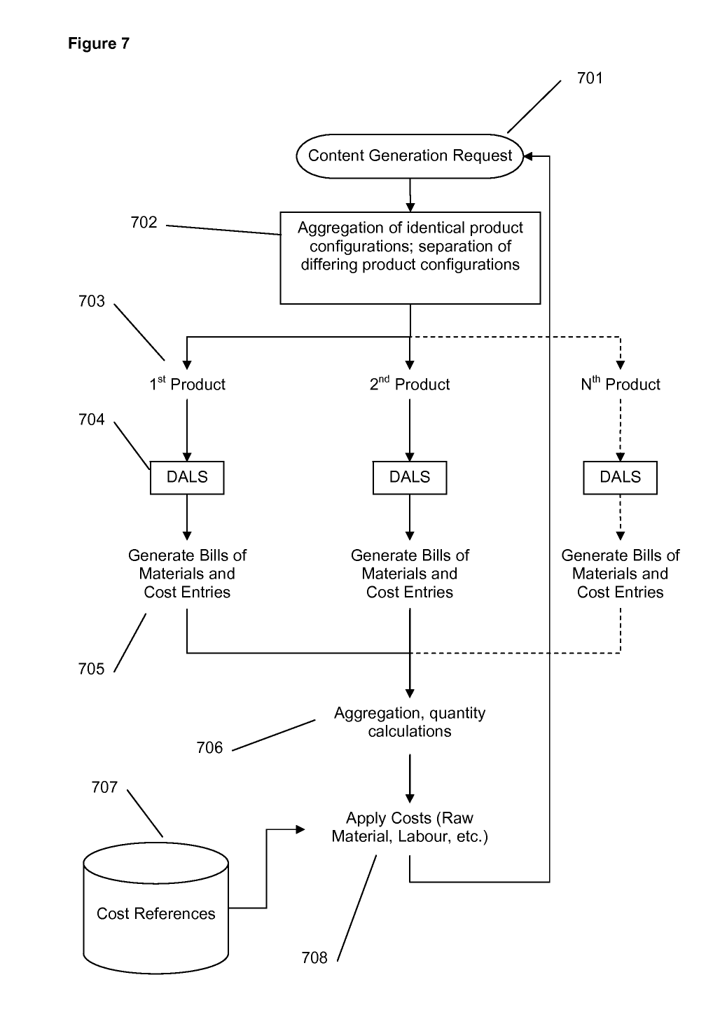

The process for generating product costing, which is depicted in FIG. 7, begins with a Content Generation Request 701 which contains pertinent information (e.g., model configuration parameters) defining the context. If the Content Generation Request 701 indicates that multiple product configurations are to be costed, the system may inspect the configurations to collect any identical sets together to reduce processing time 702. Once all unique product configurations are identified, the system may process all configurations simultaneously (or as many at once that the hardware in which the system resides allows) 703. Configurations are passed into the Dynamic Assembly Logic System 704 to build virtual representations of the model configurations and then to generate a collection of cost entries 705. Identical cost entries are then aggregated and quantities calculated 706 based on the amount of configurations initially inputted. At this point, the system may retrieve from the database any Cost References 707 that match the cost entries 708. For example, a cost entry may have properties stating that it is an aluminum extrusion twenty inches long, so the system will retrieve from the database a Cost Reference for aluminum extrusion which may specify that it costs $0.18 per inch. The system will multiply this cost against the length, and then multiply it against the quantity of that part to get a final total. Finally, the system supplies the costing information back to the originator of the Content Generation Request 701 where it may be used accordingly.

When the Product Specification Application submits a Content Generation Request to produce manufacturing drawings and/or manufacturing BOMs, the system may utilize the following process. First, the Model Family and the associated model configuration parameters are used to create the Content Generation Request. The Content Generation Request may be executed immediately but is typically queued in the database as this process may take several minutes depending on the complexity of the Product Definition 11 and the speed at which the employed EGAD Application (e.g., Pro/ENGINEER, SolidWorks, or CATIA) operates. If queued, a client EGAD Controller Service running on a separate computer (although not preferred, the processing application may reside on the same physical hardware that the current embodiment implementation resides) may assign itself the Content Generation Request. The EGAD Controller Service then generates a set of instructions on what product configuration family to load, which drawings to generate, and the input parameters to configure the product. The EGAD Controller Service may optionally execute a product configuration skeleton to produce a set of geometrical and analytical parameters that would drive the EGAD Application. The instruction set is then fed into a specific EGAD Connector program. The EGAD Connector is designed to read these instructions and in turn automate the EGAD Application. The EGAD Application is instructed by the EGAD Connector to load and configure the specified model family and produce relevant Manufacturing Drawings and/or Manufacturing BOMs. The EGAD Controller service then reads in the produced Manufacturing Drawings and Manufacturing BOMs and passes them back to the database fulfilling the Content Generation Request.

When the Product Specification Application submits Content Generation Requests, typically made by a user of the software, to produce 3D visualizations, the system may utilize the following process. First, the Model Family and the associated model configuration parameters are used to create the Content Generation Request. The Model Family and model configuration parameters are fed into the DALS to produce the virtual representation of the model configuration. At this point, the system executes the visualization logic associated with the parts and assemblies of the virtual representation of each model configuration. The visualization logic will produce 3D geometry and texturing information and may optionally use imported 3D Assets. Once the system has all the necessary 3D information in a generic form, it can be run through several different processes or conversions depending on the required 3D Visualization type.

If generating a 3D PDF, the system will convert the 3D information into a U3D file which is then embedded into a PDF document. If generating a downloadable 3D format for manual import into an external 3D modeling application, the system will convert the 3D information into the Wavefront OBJ format and package the mesh and any necessary texturing images and information together. If generating a 2D preview raster image, the system feeds the 3D information into a DirectX, OpenGL, or other rendering engine software to produce a bitmap. The system provides an API for user instructions in DALS to indicate if the particular model configuration is two-sided (that is, it looks different from the front than the back) and if so, the system will make two renderings—one from the front and one from the back—and merge the bitmaps together side-by-side automatically. Finally, the system may convert the bitmap into a compressed, web-transmittable format (e.g., PNG, JPG) to complete the request. Other 3D formats and outputs may be provided as well and they may follow similar procedures as outlined above.

It should be recognized that the Core Framework 20 may provide a suite of interfaces and powerful tools streamlined for the use of product configuration, typically for use over a network, to employ a centralized database, and to be used by multiple clients simultaneously. As the Core Framework 20 is an adaptable system, it does not need to run over a network, nor require a centralized database, nor be used by multiple users simultaneously. Such architectural structures would be dependent on the intended purpose of a particular Product Definition's 11 embodiment and those knowledgeable in the field would appreciate that the described embodiments and Product Definitions 11 are provided as examples only.

In a preferred embodiment, the system may be implemented as a client-server architecture, with the Product Specification Application 22 running in a browser window on a client computer and the Core Framework 20 running on a centralized server. The Product Specification Application 22 may use exclusively standard commercial off-the-shelf applications, such as Internet Explorer, Flash, Shockwave and Acrobat; also that no custom or non-standard components reside on the client. The use of standard off-the-shelf software eliminates the need for maintenance of client desktop computers by the server software vendor or service provider, and significantly lowers the total cost of ownership or use of the system compared to approaches employing custom client software.

In other embodiments, alternatives such as an installed GUI application or a command line driven console application may provide the same functionality.

The system may provide a rich suite of APIs, and be designed to work fluidly with web services and web portals allowing other embodiments to create their own completely custom applications that interface with the exposed components of the server-based components of the system. So whether the embodiment uses off-the-shelf software or proprietary applications is inconsequential as long as they can communicate with the server-based components of the system using industry standard interfaces.

While a client-server configuration is a preferred approach, the system can alternatively run as a stand-alone desktop application with all the software executing on a stand-alone computer system.

The functionality of the system may be implemented by software modules, including the Product Specification Application 22, Core Framework 20, Content Generation 21, and Product Data Load 23, running on one or more programmable processors or may alternately be implemented by hard-wired computer logic, or a combination of the two. The software may include executable code stored in a memory for execution by a processor. A memory may include any static, transient or dynamic memory or storage medium, including without limitation read-only memory (ROM) or programmable ROM, random access registers memory (RAM), transient storage in registers, or electrical, magnetic, quantum, optical, holographic or electronic storage media. A process includes any device or set of devices, howsoever embodied, whether distributed or operating in a single location, that are designed to or have the effect of carrying out a set of instructions, but excludes an individual or person. A system implemented in accordance with the present invention may comprise a computer system having memory and a processor to execute the code.

The invention is described herein primarily in reference to its use as a space plan design system, but it will be clear to skilled persons that the invention provides for a generic, integrated, parametric, automatic configuration system that can be used to configure any configurable product, such as filing cabinets and windows. It may also be used for managing and inventory control of furniture inside buildings (such as apartments and offices) or for HVAC planning, electrical installations, and auditorium seating arrangements.

It will be appreciated that the above description relates to the described embodiments by way of example only. Many variations on the system and method for delivering the invention without departing from the spirit of same will be clear to those knowledgeable in the field, and such variations are within the scope of the invention as described and claimed, whether or not expressly described.

What is claimed is:

1. A product configuration system comprising:
a. A sketcher module for generating and displaying a product design from parameterized model configurations in real-time as a user specifies the model configurations and their parameter values; and
b. A dynamic assembly logic module for generating a costing and a bill of materials for the product design at the request of the user as the user specifies the model configurations and their parameter values.

2. The system of claim 1 wherein the sketcher module and dynamic assembly logic module are implemented in software designed to run on one or more programmable processors.

3. The system of claim 1 wherein the model configurations include wall panels and doors.

4. The system of claim 1 wherein the dynamic assembly logic module also automatically generates manufacturing drawings at the request of the user.

5. The system of claim 1 further comprising a rule engine module for validating the product design in real-time as the user specifies the model configurations and their parameter values.

6. The system of claim 5 wherein the rule engine module also identifies model configurations missing from the product design and automatically adds them to the product design.

7. The system of claim 5 wherein the rule engine module evaluates parameter values for validity.

8. The system of claim 7 wherein the rule engine compares multiple parameters against each other.

9. The system of claim 1 further comprising a logic converter module for importing a parametric EGAD model.

10. The system of claim 1 wherein the sketcher can import a reference floor plan produced by an offline CAD program.

11. The system of claim 1 wherein the costing is computed based on the model configuration parameter values.

12. The system of claim 2 wherein the sketcher module runs on a client computer system and the dynamic assembly logic module runs on a server computer system in electronic communication with the client computer system via a network.

13. The system of claim 12 wherein the sketcher module runs in a browser window using only commercial off-the-shelf software.

14. The system of claim 1 wherein the system generates three-dimensional visualizations of the product design in real-time as the user edits the product design and displays the visualizations to the user.

15. The system of claim 14 wherein the user can edit the product design by selecting and modifying components in the product design in a three-dimensional visualization.
